(19) United States
(12) Patent Application Publication
(10) Pub. No.: US 2009/0002907 A1
(43) Pub. Date: Jan. 1, 2009

(54) Modular parallel protection circuit

(75) Inventors: Mark Alan Von Striver, Folsom, CA (US); David Walter Paterson, Orangevale, CA (US)

Correspondence Address: DLA PIPER US LLP, 2000 UNIVERSITY AVENUE, E. PALO ALTO, CA, 94303-2248, US

(73) Assignee: ALEPH AMERICA

(21) Appl. No.: 11/824,403

(22) Filed: Jun. 28, 2007

(51) Int. Cl. H02H 3/20

(52) U.S. Cl. 361/91.6; 361/91.5

(57) ABSTRACT

A modular protection circuit can protect a first terminal and a second terminal of a first device. The circuit comprises a load device which has a third terminal and a fourth terminal with the third terminal for connection to a first voltage. A first diode is provided, with the first diode having a first cathode and a first anode with the first cathode connected to the fourth terminal and the first anode connected to the first terminal. A second diode is provided with the second diode having a second cathode and a second anode with the second cathode connected to the fourth terminal and the second anode connected to the second terminal. A third diode is provided with the third diode having a third cathode and a third anode with the third cathode connected to the first terminal and the third anode connected to a second voltage. Finally, a fourth diode is provided with the fourth diode having a fourth cathode and a fourth anode with the fourth cathode connected to the second terminal and the fourth anode connected to a third voltage.

### TECHNICAL FIELD

The present invention relates to a protection circuit for protecting a device from surges in voltage or power, and more particularly, wherein the protection circuit is modular and can be used to protect a plurality of devices.

### BACKGROUND OF THE INVENTION

Electrical surge protection circuits are well known in the art. However, heretofore, the surge protection circuits have been complex and non-modular, in that a single protection circuit cannot provide protection for additional load circuits as they are desired to be protected. Hence there is a need to provide a simple modular protection circuit that can serve a plurality of devices as each device is added, requiring to be protected.

### SUMMARY OF THE INVENTION

A modular protection circuit can protect a first terminal and a second terminal of a first device. The circuit includes a load device that has a third terminal and a fourth terminal with the third terminal for connection to a first voltage. The load device is a clamping device well known in the art. These include but are not limited to a Metal Oxide Varistor, Transient Voltage Suppressor, Zener Diode, Gas Discharge Tube, or Neon Bulb. These types of clamping devices are intended to allow a certain amount of voltage to be applied across their terminals without conduction. However if their clamping voltage is reached they will begin to conduct. In this way they can limit the voltage across their terminals thereby protecting a circuit connected in parallel. A first diode is provided, with the first diode having a first cathode and a first anode with the first cathode connected to the fourth terminal and the first anode connected to the first terminal. A second diode is provided with the second diode having a second cathode and a second anode with the second cathode connected to the fourth terminal and the second anode connected to the second terminal. A third diode is provided with the third diode having a third cathode and a third anode with the third cathode connected to the first terminal and the third anode connected to a second voltage. Finally, a fourth diode is provided with the fourth diode having a fourth cathode and a fourth anode with the fourth cathode connected to the second terminal and the fourth anode connected to a third voltage.

### BRIEF DESCRIPTION OF THE DRAWINGS

FIG. 1 is a circuit diagram of a modular protection circuit of the present invention.

### DETAILED DESCRIPTION OF THE INVENTION

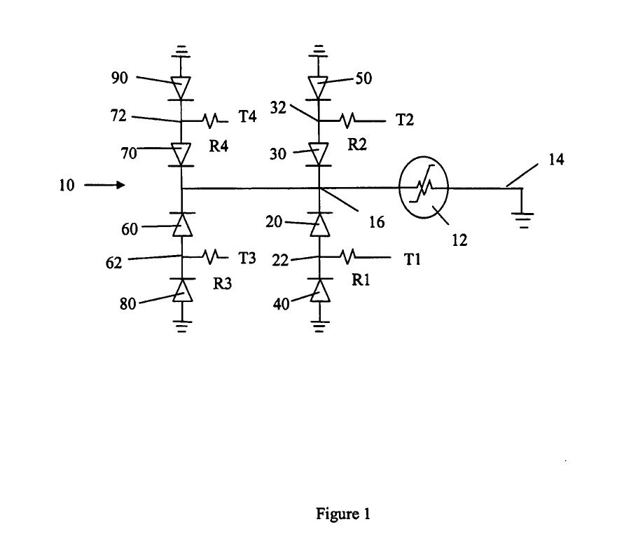

Referring to FIG. 1 there is shown a circuit diagram of a modular protection circuit 10 of the present invention. The protection circuit 10 comprises a load device 12, such as a Metal Oxide Varistor (MOV) 12. The MOV 12 has a first end 16 and a second end 14 with the second end 14 connected to a voltage, such as ground. The load device 12 can also be a Transient Voltage Suppressor, Zener Diode, Gas Discharge Tube, or Neon Bulb. These types of clamping devices are intended to allow a certain amount of voltage to be applied across their terminals without conduction. However if their clamping voltage is reached they will begin to conduct. In this way they can limit the voltage across their terminals thereby protecting a circuit connected in parallel. The modularity of the protection circuit 10 can be seen as follows.

To protect a first device (not shown) that has two terminals T1 and T2, the following electrical components are provided. A first resistor R1 connects the terminal T1 to node 22. A second resistor R2 connects the terminal T2 to node 32. A first diode 20 has a first cathode and a first anode, with the first cathode connected to the node 16, and the first anode connected to node 22. A second diode 30 has a second cathode and a second anode, with the second cathode connected to the node 16, and the second anode connected to node 32. A third diode 40 has a third cathode and a third anode with the third cathode connected to node 22 and the third anode connected to a voltage such as ground. Finally, a fourth diode 50 has a fourth cathode and a fourth anode with the fourth cathode connected to node 32 and the fourth anode connected to a voltage such as ground.

The operation of the protection circuit 10 is as follows. Assume that there is a positive voltage surge at terminal T1. In that event, the positive surge voltage (typically a spike) passes through the resistor R1 and through the first diode 20 and through the load 12 to ground 14. In the event a negative surge voltage occurs at terminal T2, the energy is shunted directly to ground. The fourth anode of fourth diode 50 is connected to ground. Thus, current from ground through the fourth diode 50 would pass to the node 32 and through resistor R2 to the second terminal T2.

The modularity of the protection circuit 10 can be seen as follows. In the event it is desired to use the protection circuit 10 with a second device, having terminals T3 and T4, the following components are provided. A third resistor is connected between the terminal T3 and a node 62. A fourth resistor R4 is connected between the terminal T4 and a node 72. A fifth diode 60 has a fifth cathode and a fifth anode, with the fifth cathode connected to the node 16, and the fifth anode connected to node 62. A sixth diode 70 has a sixth cathode and a sixth anode, with the sixth cathode connected to the node 16, and the sixth anode connected to node 72. A seventh diode 80 has a seventh cathode and a seventh anode with the seventh cathode connected to node 62 and the seventh anode connected to a voltage such as ground. Finally, an eighth diode 90 has an eighth cathode and an eighth anode with the eighth cathode connected to node 72 and the eighth anode connected to a voltage such as ground.

The operation of the protection circuit 10 for the second device is similar to that described for the protection of the first device. The load 12 through which current dissipates is common to operation for the protection of the first device and for the second device. The current from the second device would flow through terminals T3 or T4 and through the diodes 60, 70, 80 and 90 in the same manner that has been described for the flow of current from the first device through terminals T1 and T2.

It should also be noted that if the diodes and load device are robust enough to accept surge peak currents, the resistors are not necessary. They are included in the example as current limiting devices to help dissipate some of the surge energy.

From the foregoing it can be seen that the protection circuit 10 is modular and simple and can be simply added as additional loads are desired to be protected. The invention allows a single protection device (load 12) to service a plurality of terminals with the simple addition of “steering diodes”, such as diodes 60, 70, 80 and 90. Although the technique described herein may employ more components than some other solutions due to the “steering diodes”, the additional components are very inexpensive.

What is claimed is:

1. A modular protection circuit for protecting a first terminal and a second terminal of a first device, said circuit comprising:
a load device having a third terminal and a fourth terminal; said third terminal for connection to a first voltage;
a first diode having a first cathode and a first anode with the first cathode connected to the fourth terminal and the first anode connected to the first terminal;
a second diode having a second cathode and a second anode with the second cathode connected to the fourth terminal and the second anode connected to the second terminal;
a third diode having a third cathode and a third anode with the third cathode connected to the first terminal and the third anode connected to a second voltage; and
a fourth diode having a fourth cathode and a fourth anode with the fourth cathode connected to the second terminal and the fourth anode connected to a third voltage.

2. The circuit of claim 1 for further protecting a fifth terminal and a sixth terminal of a second device, wherein said protection circuit further comprising:
a fifth diode having a fifth cathode and a fifth anode with the fifth cathode connected to the fourth terminal and the fifth anode connected to the fifth terminal;
a sixth diode having a sixth cathode and a sixth anode with the sixth cathode connected to the fourth terminal and the sixth anode connected to the sixth terminal;
a seventh diode having a seventh cathode and a seventh anode with the seventh cathode connected to the fifth terminal and the seventh anode connected to the second voltage; and
an eighth diode having an eighth cathode and an eighth anode with the eighth cathode connected to the sixth terminal and the eighth anode connected to the third voltage.

3. The circuit of claim 1 wherein said load device is a metal oxide varistor, transient voltage suppressor, zener diode, gas discharge tube, or neon bulb.

4. The circuit of claim 1 wherein said first voltage, second voltage and third voltage are ground voltages.

5. The circuit of claim 1 further comprising:
a first load connected between the first terminal of the first device and the first anode of the first diode;
a second load connected between the second terminal of the first device and the second anode of the second diode.

6. The circuit of claim 5 wherein each of said first load and second load is a resistor.

7. The circuit of claim 2 further comprising:
a first load connected between the first terminal of the first device and the first anode of the first diode;
a second load connected between the second terminal of the first device and the second anode of the second diode;
a third load connected between the fifth terminal of the second device and the fifth anode of the fifth diode;
a fourth load connected between the sixth terminal of the second device and the sixth anode of the sixth diode.

8. The circuit of claim 7 wherein each of said first load, second load, third load and fourth load is a resistor.
